(19) United States
(12) Patent Application Publication
(10) Pub. No.: US 2001/0050316 A1
(43) Pub. Date: Dec. 13, 2001

(54) FUEL INJECTION VALVE

(76) Inventors: RUDOLF HEINZ, RENNINGEN (DE); ROGER POTSCHIN, BRACKENHEIM (DE); FRIEDRICH BOECKING, STUTTGART (DE)

Correspondence Address: RONALD E GREIGG, Greigg & Greigg P.L.L.C, 1423 Powhatan Street, Unit One, Alexandria, VA, 22314, US

(21) Appl. No.: 09/254,049

(22) PCT Filed: Mar. 14, 1998
(86) PCT No.: PCT/DE98/00764

§ 371 Date: None

(30) Foreign Application Priority Data
Jul. 1, 1997 (DE) 19727896.5

(51) Int. Cl. F02M 41/16

(52) U.S. Cl. 239/96; 239/533.3

(57) ABSTRACT

A fuel injection valve having a valve member that is controlled by the pressure in a control pressure chamber and whose opening motion is influenced by way of a compensation pressure face of the valve member. This compensation pressure face adjoins a hydraulic chamber whose pressure is controlled with the aid of a piston which reduces the hydraulic initial stress of the hydraulic chamber, and keeps the fuel at an essentially constant value, and can compensate for volume changes of the hydraulic chamber by moving in opposition to a reference pressure.

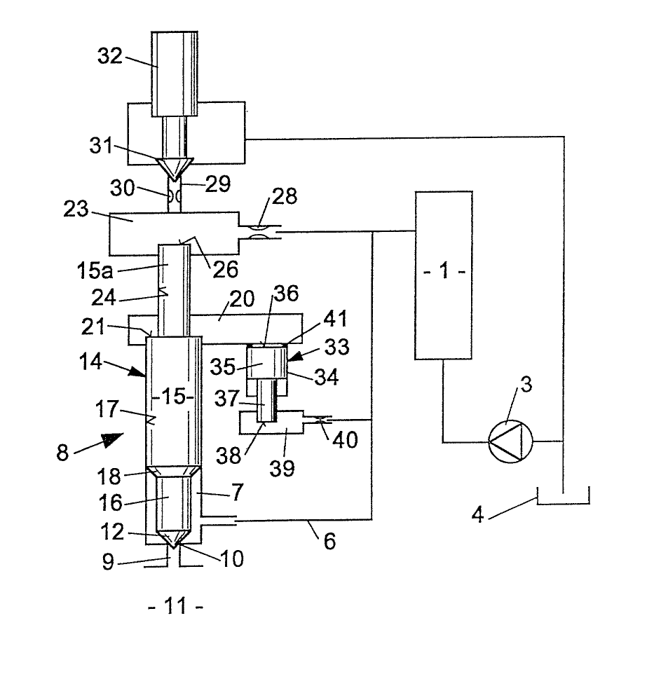

### PRIOR ART

The invention is based on a fuel injection valve according to the preamble to claim 1. In a fuel injection valve of this kind, which has been disclosed by GB 1 320 057, the actuating part of the valve member is embodied as being of one piece with this valve member. The valve member in this connection has a piston as the actuating part, which on its one end, borders the control pressure chamber with its end face and on its other end, transitions by way of a pressure shoulder into a smaller diameter part on whose end the sealing face is disposed, which controls the injection opening. The pressure shoulder is subjected to the pressure in the pressure chamber, which continuously communicates with the high-pressure fuel reservoir, which in turn continuously communicates with the control pressure chamber by way of a throttle. This control pressure chamber has a second outlet that is controlled by a piezoelectric valve. When this outlet opens, the pressure in the control pressure chamber decreases to a relief pressure, which brings about the fact that the forces in the opening direction, which act on the valve member for example by way of the shoulder, open the injection valve.

In a fuel injection valve of this type, there is the disadvantage that a precise metering of the fuel injection quantity over time and the stroke of the fuel injection valve member is not possible. When the injection valve needle opens, it lifts with its sealing face up from the valve seat and at this instant, the high fuel pressure prevailing in the pressure chamber can also act on the sealing face in the opening direction. As a result, the valve member experiences an additional force in the opening direction, which has a serious effect on the dynamic opening behavior of the valve member. The force that acts in the opening direction reaches a limit value by way of the stroke. The progression of force thereby follows an approximately exponential curve. This property impedes the metering of small fuel injection quantities in which a reclosing of the valve member is required before its end position is reached or before the maximal force that acts in the opening direction is reached. A precise metering of fuel injection quantities is primarily impeded in the intermediary stroke region.

### ADVANTAGES OF THE INVENTION

With the fuel injection valve according to the invention, according to the features of the characterizing part, it is now possible to better control the opening event of the valve member so that a more precise metering of small fuel injection quantities becomes possible. With the aid of the piston and the hydraulic chamber that is adjoined by the valve member on one end and by the piston one the other end, a stabilizing force is obtained by way of the compensation pressure face on the valve member and this force smooths the opening event of the fuel injection valve member. Immediately upon the first opening movement of the valve member, a pressure builds up in the hydraulic chamber that increases very rapidly to a maximum value, but then remains constant since starting from particular pressure, the position of the piston can change and thus the volume remains constant. In an advantageous improvement of the invention, the piston is equipped with differently sized piston faces so that the initial pressure in the hydraulic chamber is reduced in relation to the reference pressure, wherein if the pressure of the high-pressure fuel source is selected as the reference pressure, a pressure that is smaller by the reduction ratio acts in the closing direction on the compensation pressure face on the valve member. In this manner, an opposing force can be kept essentially constant on the valve member starting from a particular pressure.

Other advantages can be inferred from the remaining claims in conjunction with the following description of an exemplary embodiment.

### DESCRIPTION

The sole FIGURE schematically represents a fuel injection valve that is supplied with fuel from a high-pressure fuel reservoir 1. A high-pressure fuel pump 3 aspirates fuel from a fuel tank 4 and supplies it at high fuel injection pressure into the high-pressure fuel reservoir. From there, the fuel travels by way of a pressure line 6 into a pressure chamber 7 of the fuel injection valve 8. The pressure chamber 7 is disposed upstream of a fuel injection opening 9, which is adjoined toward the interior, in the direction of the pressure chamber 7, by a valve seat 10 and whose connection between the pressure chamber 7 and the combustion chamber 11 of an affiliated internal combustion engine is controlled by a sealing face 12 that is provided on the end of a valve member 14. The valve member has an actuating part 15 and a needle part 16, which relieves the pressure chamber 7 in a guide bore 17 of the actuating part and has a sealing face 12 on the end. In the current instance, this sealing face is embodied as conical, in accordance with a conical valve seat 10. Between the actuating part 15 and the needle part 16, a pressure shoulder 18 is formed, which is subjected to the pressure in the pressure chamber 7 in such a way that its loading produces a resultant force that acts in the opening direction of the valve member 14.

The actuating part 15 protrudes into a hydraulic chamber 20 in the housing of the fuel injection valve and has an annular shoulder 21 there which constitutes a compensation pressure face. In this connection, the actuating part 15 leads with a reduced diameter part 15a l out of the hydraulic chamber again and is guided in a guide bore 24 that feeds into a control pressure chamber 23. The actuating part 15 ends there in an end face 26 that is subjected to the pressure in the control pressure chamber 23. The control pressure chamber continuously communicates with the high-pressure fuel reservoir by way of a throttle 28. Furthermore, a relief conduit 29 leads from the control pressure chamber 23 and if need be, a second throttle 30 is disposed in this relief conduit, which can be opened or closed by means of a valve member 31 of an electrically controlled valve 32. If the valve member 31 is opened, then the pressure in the control pressure chamber is reduced to a relief pressure since more fuel flows out by way of the relief line 29 than can flow in by way of the throttle 28. With the reduction of this pressure, hence with the decreasing forces which, due to this pressure, act on the valve member in the closing direction, the hydraulic forces, which act on the valve member in the opening direction by way of the pressure shoulder 18, predominate. This means that the valve member is opened and the injection by way of the injection opening begins. In order to end this injection event, the valve member 31 is brought back in the closing direction, which results in the fact that rapidly replenishing fuel brings the control chamber pressure back to the initial value at the level of the fuel pressure in the high-pressure fuel reservoir 1. This high pressure produces a predominant force in the closing direction of the valve member 15 and initiates the closing event.

The surface areas of the end face 26 and the pressure shoulder 18 must be matched to each other so that an opening event or a closing event can be quickly and reliably carried out. In addition, it must be noted that with the lifting of the valve needle from its valve seat 10, an additional surface area is acted on by the high pressure so that increasing forces up to a limit value act on the valve member in the opening direction. The progression of these forces over the stroke of the valve member or over time is nonlinear. Consequently, it becomes more difficult to define and evaluate an opening cross section in the intermediary region of the valve needle stroke. Such reduced opening strokes of the valve needle are particularly important when extremely small fuel injection quantities are to be injected. This is required, for example, when in order to control the combustion process by way of the fuel injection valve, pre-injection quantities are to be introduced into the combustion chamber before a main injection. In order to better control the motion of the valve member, according to the invention, the hydraulic chamber 20 is provided with the compensation pressure face 21 on the annular shoulder between the actuating parts 15 and 15a. The hydraulic chamber is closed, but can be displaced. To that end, a piston 33 is provided, which is supported so that it can move in a sealed fashion in a bore that feeds into the hydraulic chamber. This piston is embodied as a stepped piston, with a larger diameter part 35 whose first piston face 36 borders the hydraulic chamber 20, and with a smaller diameter part 37 whose second piston face, its end face 38, reaches into a reference pressure chamber 39, which in turn communicates with the high-pressure fuel reservoir 1 by way of a throttle 40. The piston 33 has a stop 41 which limits the movement of the piston in the direction of the hydraulic chamber 20.

If, as already described above, an opening event of the valve member 14 is initiated, i.e. if the valve member 31 is opened and the control pressure chamber 23 is relieved to a relief pressure, then the valve member will begin to move in the opening direction. In this connection, however, the larger diameter actuating part 15 plunges further into the hydraulic chamber 20 and displaces fuel with its end face 21. This displacement initially produces a pressure increase in this hydraulic chamber due to the rigidity of the hydraulic volume and the elastic properties of the hydraulic medium contained in it. In the present case, this medium is fuel that is also present in the reference pressure chamber 29. Because of the piston 33, in the initial position, the hydraulic chamber is prestressed at a pressure that results from the ratio of the first and second piston faces 36 and 38, which are subjected to pressure. Due to the mobility of the piston, the pressure in the hydraulic pressure chamber can be kept constant, in fact at a pressure that is reduced in relation to the pressure in the reference pressure chamber or in the high-pressure fuel reservoir 1. In connection with the compensation pressure face, this pressure represents an additional loading of the valve member 14 in the closing direction, which remains essentially constant and consequently as a constant factor, determines the opening characteristic curve of the valve member in a quite significant manner. With the beginning of the opening stroke of the valve member 14, the volume in the hydraulic chamber 20 is prestressed, but is then kept constant because of the mobility of the piston 32. In addition to being determined by the piston surface area 21, the increase of the initial stress over the stroke is also significantly determined by the volume of the hydraulic chamber 20. Depending on the pressure level in the high-pressure fuel reservoir, a corrective force can be introduced counter to the opening stroke of the fuel injection valve member 14. The throttle 40 also plays a role in which the rigidity of the hydraulic column of the hydraulic chamber 20 and the reacting force on the valve member 14 can additionally be adjusted. In particular, a dynamic behavior can be corrected with this throttle in order to influence a nonlinear force increase of the forces that act on the valve member in the opening direction.

With a fuel injection valve of this kind, extremely small fuel injection quantities can be more precisely injected.

1. A fuel injection valve with a valve member (14) that opens inward counter to the outflow direction of the fuel and has a sealing face (12) that controls an injection opening (9) and upstream of it, is adjoined by a pressure chamber (7), which continuously communicates with a high-pressure fuel source (1) and is bordered by a pressure shoulder (18) on the valve member (14), which is acted on in the opening direction by the pressure in the pressure chamber (7) counter to a closing force, and with an actuating part (15, 15a) that has a pressure face (26) that is used for actuating the valve member (14) in the closing direction counter to opening forces, which pressure face is subjected to a control pressure in a control pressure chamber (23), which pressure can be changed between a working pressure and a relief pressure, wherein when a relief pressure is set there, the opening forces on the valve member (14) predominate, characterized in that a compensation pressure face (21) is provided that acts on the valve member (14) and borders a hydraulic chamber (20) on one end, which on the other end is bordered by a first piston face (36) of a piston (33), wherein the piston (33) has a second piston face (38), which is disposed remote from the first piston face (36) and is acted on by a reference pressure, preferably a constant pressure, in the closing direction of the valve member.

2. The fuel injection valve according to claim 1, characterized in that the second piston face (38) is smaller than the first piston face (36) and the pressure of the high-pressure fuel source is used as the reference pressure.

3. The fuel injection valve according to claim 1, characterized in that the compensation pressure face (21) is sized so that when the relief pressure is set, the sum of the forces that act in the closing direction is less than the sum of the forces that act in the opening direction.

4. The fuel injection valve according to claim 1, characterized in that the forces that act in the closing direction equal the sum of the forces resulting from the pressure application in the hydraulic chamber (20) plus the forces produced by the pressure face (26) and the reduced control pressure, and the forces that act in the opening direction equal the sum of the forces resulting from the pressure application of the pressure shoulder (18) and the sealing face (12).

5. The fuel injection valve according to one of the preceding claims, characterized in that the actuating part (15, 15a) has an end face (26) which borders a control pressure chamber (23) that contains the control pressure, and the control pressure chamber is relieved by means of an electrically controlled control valve (2) or can be kept at the pressure of the high-pressure fuel source.

6. The fuel injection valve according to claim 5, characterized in that the control pressure chamber (23) communicates continuously with the high-pressure fuel source (1) by way of a first throttle (28) and the control valve is a 2/2-way valve by means of which the control pressure chamber (23) can be relieved to the relief pressure in order to initiate the high-pressure injection by means of the fuel injection valve (8).

7. The fuel injection valve according to claim 6, characterized in that the relief of the control pressure chamber (23) occurs by way of a second throttle (29).

8. The fuel injection valve according to one of the preceding claims, characterized in that the path of the piston (33) in the direction of the hydraulic chamber (20) is limited by a stop (41).
